(19) United States
(12) Patent Application Publication
(10) Pub. No.: US 2016/0332165 A1
(43) Pub. Date: Nov. 17, 2016

(54) STORAGE BOX FOR A PLURALITY OF TUBULAR VESSELS OR OTHER ELONGATE ARTICLES

(71) Applicant: EPPENDORF AG, Hamburg (DE)

(72) Inventor: Christopher Günther, Hamburg (DE)

(73) Assignee: Eppendorf AG, Hamburg (DE)

(21) Appl. No.: 15/112,239

(22) PCT Filed: Jan. 21, 2014
(86) PCT No.: PCT/EP2014/051110

§ 371 Date: Jul. 18, 2016

(51) Int. Cl. B01L 9/06; B65D 43/16; B65D 25/10

(52) U.S. Cl. CPC B01L 9/06; B65D 25/108; B65D 43/164; B01L 2200/028; B01L 2200/025; B01L 2300/043

(57) ABSTRACT

A storage box for a plurality of tubular vessels includes a box housing which has a housing base with a bottom wall, side walls and a top housing opening. It includes a housing extension shiftable to a stowed position or an extended position in which the housing base is elongated. Several strip-shaped carrier elements, which, in each case, have a row of parallel holders for elongated objects are parallel and next to each other. Coupling elements connect adjacent carrier elements. Guide elements at the carrier elements guide them perpendicularly during an extension. In the stowed position, all carrier elements in the housing base are moved together and, in the extended position, can be shifted apart, so that a portion of the carrier elements is disposed in the housing base and a further portion of the carrier elements is shifted into the housing extension.

### CROSS-REFERENCE TO RELATED APPLICATIONS

This application is a national stage entry from PCT/EP2014/051110 filed on Jan. 21, 2014.

### BACKGROUND OF THE INVENTION

The invention relates to a storage box for a plurality of tubular vessels or other elongated objects.

The inventive storage boxes are used particularly for storing vessels, filled with laboratory samples (such as blood, sperm, organisms), in freezers at low temperatures of, for example, −85° C. Special tubular vessels, used for this purpose, are also referred to as “cryo vessels”. Cryo vessels frequently have a capacity ranging from 0.5 to 10 mL and especially of 1.5, 1.8 or 2.0 ml. They are offered, for example, by the Biosigma Company under the product name of “CryoGen® tubes”. A cryo vessel from this manufacturer is the subject matter of the Italian patent application IT VE 20080076 A. The inventive storage box may, however, also be used for other purposes, for example, for carrying out reactions in vessels at low temperatures or for storing any desired elongated objects (such as rotating dental instruments during sterilization).

Storage boxes for keeping cryo vessels in the freezer are also referred to as “cryo box”, “freezer box” or “storage box”. Conventional cryo boxes of cardboard or plastic have a lower housing part with a plurality of holders in a matrix arrangement for cryo vessels. The lower part of the housing, filled with vessels, can be closed off by a housing lid, which may be constructed as a slip lid or a hinged lid. Cryo boxes, which are rectangular in plan view, have horizontal dimensions ranging from 132×132 mm to 136×136 mm and particularly of 135×135 mm.

For the space-saving accommodation in freezers, the holders in the cryo boxes are separated by a small distance from one another, so that the vessels are disposed very close together. This makes the removal of individual vessels more difficult, especially if the user is wearing gloves. For this reason, users frequently pull off the gloves, so that hands and vessels are not protected.

Under the product name “Work2Store™ Expanding Storage Box”, the company Heathrow Scientific markets cryo boxes of polypropylene with a housing base, which consists of eight strip-shaped carrier elements with, in each case, eight holders for cryo vessels, which are coupled together at their ends by coupling elements. The coupling elements are clips, which enclose a slot, which is engaged by flat projections of two adjacent carrier elements. In a pushed-together position, in which neighboring carrier elements fit laterally against one another, a slip lid can be placed on the housing base with inserted cryo vessels in order to accommodate the latter in a space-saving and protected manner in the freezer. After the slip lid is removed, the carrier elements can be pulled apart until the projections sit closely at the ends of the clips. In the pulled-apart position, there are gaps between adjacent carrier elements, as a result of which the removal of individual cryo vessels is facilitated. These cryo boxes are described in the WO 2013/184306 A1 and in US patent 2013/0330254 A1.

The known cryo boxes have the disadvantage that the slip lid must be removed and put down separately, before the housing base can be loaded with cryo vessels or cryo vessels can be removed therefrom. Moreover, the housing base is unstable, because the carrier elements are held together only at the ends by plastic clips. Therefore, for pulling the carrier elements apart or pushing them together and for loading with cryo vessels or removing them, the carrier elements preferably are set down on a support. If the user holds the carrier elements by hand during these processes, there is a high risk that the cryo vessels will fall out and break. A further disadvantage of the cryo box is that the pulling apart of the carrier elements or pushing them together can easily be prevented by the formation of ice. In particular, ice may be formed when the cooled cryo box is exposed to room air, so that the humidity of the air resublimes on the surface of the cryo box. The components, which are to be shifted relative to one another, can be connected firmly to one another by the ice. The low number of receptacles (8×8) is a further disadvantage.

### SUMMARY OF THE INVENTION

Starting out from the above, the invention is based on the objective of creating a storage box for a plurality of tubular vessels or other elongated objects, which simplifies the handling of the elongated objects.

The inventive storage box for a plurality of tubular vessels or other elongated objects has
a box housing comprising
a housing base with a bottom wall, side walls and a top housing opening and
a housing extension, which can be shifted from a stowed position, in which the housing extension forms a compact arrangement with the housing base, into an extended position, in which the housing extension elongates the housing base in a direction parallel to the bottom wall.
several strip-shaped carrier elements, which, in each case, have a row of parallel holders for elongated objects and are disposed parallel to and next to one another in the box housing,
coupling elements, which connect adjacent carrier elements with one another, so that they can be pulled apart perpendicularly to their longitudinal axes up to a defined distance from one another,
guiding elements at the carrier elements and at the box housing, which guide the carrier elements in the box housing perpendicularly to their longitudinal axes when there is a shift,
wherein, in the stowed position, all carrier elements in the housing base are moved together and, in the extended position, can be shifted apart, so that a portion of the carrier elements is disposed in the housing base and a further portion of the carrier elements is shifted into the housing extension.

For the inventive storage box, the carrier elements are arranged in the housing base when they are moved together and arranged partly in the housing base and partly in the housing extension when they are moved apart. Accordingly, moved-together and moved-apart they are being held by the box housing. This favors the loading and unloading of elongated objects without setting the storage box down on a support. Instead, the user can hold the storage box with one hand and, with the other, conveniently load objects into or remove them from the holders in the moved-apart carrier elements through the top housing opening. Furthermore, due to the protected accommodation of the carrier elements in the storage box, icing of the components, which are movable relative to one another, is reduced so that the ability to press the carrier elements together or move them apart is guaranteed. Shifting the carrier elements into the moved together or pulled apart position is particularly simple and safe due to the defined guidance in the box housing. The pulling apart or moving together may optionally be accomplished by tilting the storage box somewhat with respect to the horizontal, so that the carrier elements automatically are pulled apart or moved together under the influence of gravity. Because of the combination in the box housing, more compact strip-shaped carrier elements can be attained than in the above-mentioned prior art, in which the carrier elements, together with the coupling elements, form a self-supporting lower housing part. In the stowed position of the storage box, the housing base and the housing extension assume a compact arrangement. A compact arrangement is understood, in particular, to be an arrangement, in which the housing extension covers the housing base as a housing lid or the housing extension and the housing base are nested in one another or pushed into each other. Consequently, a larger number of elongated objects can be accommodated in a particular base area (such as 9×9) of the inventive storage boxes than could in the previously known storage boxes. In the extended position of the storage box, individual elongated objects can particularly easily be moved into or out of the carrier elements. For this purpose, the gap between the moved-apart carrier elements preferably is finger-wide, preferably 5 mm to 15 mm. A further advantage is that the storage box can continue to be used even after the mechanics, which prevent the pushing together or pulling apart of the carrier elements, are damaged, since the carrier elements are held in the box housing. Over all, the inventive storage box simplifies the handling of tubular vessels and of other elongated objects.

In accordance with a preferred design, the box housing has a housing lid, which can be shifted from a closed position, which covers the top housing opening, into an open position, which releases the top housing opening. The contents of the box housing are protected by the housing lid, especially against contamination and the formation of ice. Alternatively, the storage box may not have a housing lid. A storage box without a housing lid can also be used for handling and accommodating tubular vessels or other elongated objects in a space-saving and limited protected manner. In case of need, a storage box without a housing lid can also be closed off, for example by means of a plastic film or by placing a further storage box on it.

In accordance with a preferred design, the housing lid, at the same time, is the housing extension, wherein the closed position of the housing lid is the stowing position of the housing extension and the open position of the housing lid is the extended position of the housing extension. Expenses can be reduced with this design, because the housing lid, at the same time, fulfills the function of the housing extension. Furthermore, the operation is simplified because the stowed position is achieved at the same time as the closed position and the extended position is achieved at the same time as the open position. Alternatively, the storage box has a housing extension as well as a housing lid. For example, after a housing lid, which is constructed as a slip lid, is removed, a drawer-like housing extension can be pulled out of the housing base and, after the drawer-like extension is pushed into the housing base, the housing lid can be placed on the housing base.

In accordance with a preferred design, the housing lid is connected over a hinge with the housing base and can be folded from the closed position covering the top housing opening into an open position directed away from the housing base. The pivoting angle between the closed position and the open position of the housing lid preferably is 180°. For this design, the extended position or the stowed position are achieved simply by swiveling the housing lid open or shut. Alternatively, for example, a housing lid, constructed as a slip lid, can be placed on the housing base and fixed to one side of the housing base in order to form the housing extension.

In accordance with a preferred design, the housing base has side walls protruding from three edges of the bottom wall, a rear housing opening between two parallel side walls at a fourth edge of the bottom wall and first hinge elements at the edges of the two parallel side walls adjacent to the rear housing opening. The housing lid has a covering wall, lid side walls protruding from three edges of the covering wall, a rear lid opening between two parallel lid side walls at a fourth edge of the covering wall and second hinge elements at the edges of the parallel lid side walls next to the rear lid opening, wherein the first and second hinge elements form the hinge between the housing base and the housing lid. Furthermore, there is a rear side wall, which can be shifted and is guided by means of guide elements at guide elements of the box housing, covers the rear housing opening and the rear lid opening in the closed position of the housing lid and, in the open position of the housing lid can be shifted with carrier elements through the rear housing opening and through the rear lid opening into the housing lid. For this design, the box housing in the closed position, advantageously, is closed by the rear side wall. In the open position, the carrier elements are framed and protected by the side walls and the lid side walls. In the closed position, the elongated objects can engage the housing base and the housing lid in a space-saving manner.

In accordance with a further design, the box housing and the rear side wall have locking elements, which hold the rear side wall in the closed position of the housing lid in the rear housing opening and in the lid opening. An unintended opening of the rear side wall in the closed position of the housing lid is avoided by these means. The locking elements may be designed so that they have to be manipulated separately by the user in order to lock and unlock the rear side wall.

In accordance with a preferred design, the locking elements are locked by swiveling the housing lid into the closed position and unlocked by swiveling the housing lid into the open position. For this purpose and in accordance with a further design, the locking elements have spigot parts with a partially circular cross-section, which protrude from the parallel side walls, and spigot parts with a partially circular cross-section, which protrude from the rear side wall, the spigot parts lie in contact with one another in the closed position and complement one another into spigots, and the locking elements have sleeves, which protrude from the upper side walls, with sleeve openings, which extend over a circumferential section, wherein the sleeves, in the closed position, enclose the moved-together spigot parts, so that the side wall, which can be shifted, is held fast and, in the open position, the sleeve openings release the spigot parts of the rear side wall, so that this can be shifted into the housing lid. For this design, the spigot parts of the parallel side walls and the rear side wall complement one another into spigots with a full circular cross-section or a partially circular cross-section, around which the sleeves of the housing lid can be swiveled. In the closed position, the sleeves of the spigot parts hold the spigots together and, in the open position, the sleeve openings of the sleeves release the spigot parts of the rear side wall, so that this can be shifted together with the carrier elements into the housing lid, which has been swiveled open.

In accordance with a further design, a rear carrier element, which is adjacent to the rear side wall, is connected firmly with the rear side wall and a front carrier element, which is adjacent to the front side wall, is connected firmly with the housing base. In this way, the carrier elements can be pulled apart by moving the rear side wall out of the rear housing opening and moved together by shifting the rear side wall into the rear housing opening. Accordingly, the rear side wall can be used as a handle for pushing the carrier elements together and pulling them apart. In accordance with a preferred design, the rear side wall has a handle for this purpose in the form of a bracket, which sticks up.

In accordance with a further design, the edges of the parallel side walls and of the bottom wall project forward underneath the first joint parts and come into contact with the edges of the parallel lid walls and of the covering wall in the open position, which are adjacent to the rear lid opening, at the forward projecting edges of the side walls and the bottom wall. For this design, the housing base and the housing extension adjoin one another smoothly in the extended position. For an alternative design, the hinges protrude from the storage box, so that the termination is not smooth.

In accordance with a further design, the rear wall is connected at the lower edge with a part of the bottom wall part, which engages the housing base in the closed position and, when the rear side wall is shifted into the housing lid, can be shifted partly out of the housing base. In the closed position, the part of the bottom wall covers the gap between the rear side wall and the rear edge of the bottom wall, which protrudes forward.

In accordance with a further design, the bottom wall has lower sliding ribs on the upper side and the bottom wall part has upper sliding ribs on the underside, the upper sliding ribs and the lower sliding ribs being aligned at an angle to one another, so that the upper sliding ribs and the lower sliding ribs contact one another at crossing places. Due to this design, the force, which must be applied in order to shift the bottom wall part out of the housing base, is reduced. Furthermore, the danger of the bottom wall part becoming stuck due to the formation of ice at the bottom wall is reduced.

In accordance with a further design, the upper side of the bottom wall has supporting ribs, which are parallel to the guiding elements and the bottom wall part has parallel slots, which are dimensioned so that they take up the supporting ribs, which protrude upward out of the slots. By these means, the supporting ribs can support vessels, which are inserted in the carrier elements and the holders of which do not have a bottom for supporting the inserted vessels. Alternatively, the holders have a bottom or a supporting element at the underside in order to support the vessels.

In accordance with a further design, the coupling elements have brackets, which protrude on the same side from the two ends of the carrier elements perpendicularly to the longitudinal axis thereof, and have locking hooks at the free ends, which engage an engagement region, which is bounded by a latching protrusion, at the lateral edges of a neighboring carrier element. A structurally particularly simple and a coupling of the carrier elements with one another, which is particularly advantageous for the manufacture and assembly, is made possible by this design.

In accordance with a further design, the coupling elements, at the same time, are guiding elements for the carrier elements and the guiding elements of the box housing are grooves or parallel projections at the insides of the side walls and/or the lid side walls, which are engaged by the coupling elements. For this design, the carrier elements are held parallel to one another, so that tilting/friction is reduced and the force expended is reduced by combining coupling elements and guiding elements. This design is particularly advantageous when the coupling elements are constructed as brackets, which, like rails, slide in grooves of the box housing. For an alternative design, the coupling elements and the guiding elements are not combined.

In accordance with a further design, each carrier element is provided with an individual first marking and, next to each row with holders of different carrier elements, the box housing has an individual second marking. This favors the identification of individual holders and of the vessels or other objects disposed therein. Possible alternatives of the marking are a numeric/alphanumeric inscription of the individual holders, an L-shaped inscription of the housing (corresponding to multiwell plates with a row of numbers on one side and a row of letters perpendicular thereto) or a numeric/alphanumeric inscription of the lid. Preferably, alphanumeric markings are used.

In accordance with a further design, there are stacking aids, for example in the form of interlocking projections, at the underside of the bottom wall and the upper side of the covering wall. The stacking aids favor a space-saving and secure accommodation of several storage boxes of the same type in stacks.

In accordance with a further design, the housing base and/or the housing lid have/has at least one drainage hole. The drainage hole favors the drainage of liquids, for example, of condensed water and, with that, reduces the risk of icing.

In accordance with a further design, the storage box has nine carrier elements with nine accommodating holes each. This design is possible because of the relatively small space required by the carrier elements in the case of a storage box with a base area of 135×135 mm. This favors a particularly space-saving accommodation of the vessels or other objects.

In accordance with a further design, each holder has an anti-rotation device at the lower end. This anti-rotation device makes it easier to open a vessel having a screw top, when the latter is disposed in the carrier element. It consists, for example, of an angular cross-section of the storage holes or of axially directed projections at the lower end of the holders, which interact with corresponding contours or projections of the vessels or other objects.

In accordance with a further design, the storage box is produced partly or completely from polycarbonate (PC). In accordance with a further design, the storage box is produced partly or completely from polyamide (PA), acrylonitrile-butadiene-styrene copolymer (ABS), polypropylene (PP) or polystyrene (PS). The polyarbonate design is preferred for use at very low temperatures, such as those, which exist when liquid nitrogen is used (−196° C.). In particular, the storage box can be used for shock freezing samples by immersing them in liquid nitrogen.

In the present application, the references to “top” or “bottom” refer to an arrangement of the storage box with the bottom part of the housing on a support and the top opening of the housing at the upper side.

### BRIEF DESCRIPTION OF THE SEVERAL VIEWS OF THE DRAWINGS

The invention is described in greater detail below by means of the drawings, in which:

FIGS. 1a-c 1b) show the storage box closed (FIG. 1a), open with vessels in moved-apart carrier elements (FIG. 1b) and open with moved-apart carrier elements without vessels (FIG. 1c), in each case in a perspective view at an angle from above and from the side;

FIGS. 2a-d show a housing base (FIG. 2a), housing, lid (FIG. 2b), slider (FIG. 2c) and carrier element (FIG. 2d) of the same storage box, in each case in a perspective view at an angle from above and from the side;

FIGS. 3a+b show the housing base of the same storage box in a plan view (FIG. 3a) and in a view from the rear (FIG. 3b);

FIGS. 4a-d show the housing lid of the same storage box in a plan view (FIG. 4a), front view (FIG. 4b), in a view from the rear and in a view from the right side (FIG. 4d);

FIGS. 5a-e show the slider of the same storage box in a plan view (FIG. 5a), in a view from the rear (FIG. 5b), a view from the left side (FIG. 5c), a perspective view at an angle from below (FIG. 5d) and a perspective view at an angle from above (FIG. 5e);

FIGS. 6a-c show a carrier element of the same storage box in a plan view (FIG. 6a), in a view from the rear (FIG. 6b) and in a view from the right side (FIG. 6c);

FIGS. 7a+b show a closed storage box in a front view with a break-out (FIG. 7a) and opened in a side view with a break-out (FIG. 7b);

FIGS. 8a+b show a storage box with a partially closed housing lid in a view from the left side with a break-out (FIG. 8a) and a closed storage box in a view from the left side with a break-out (FIG. 8b);

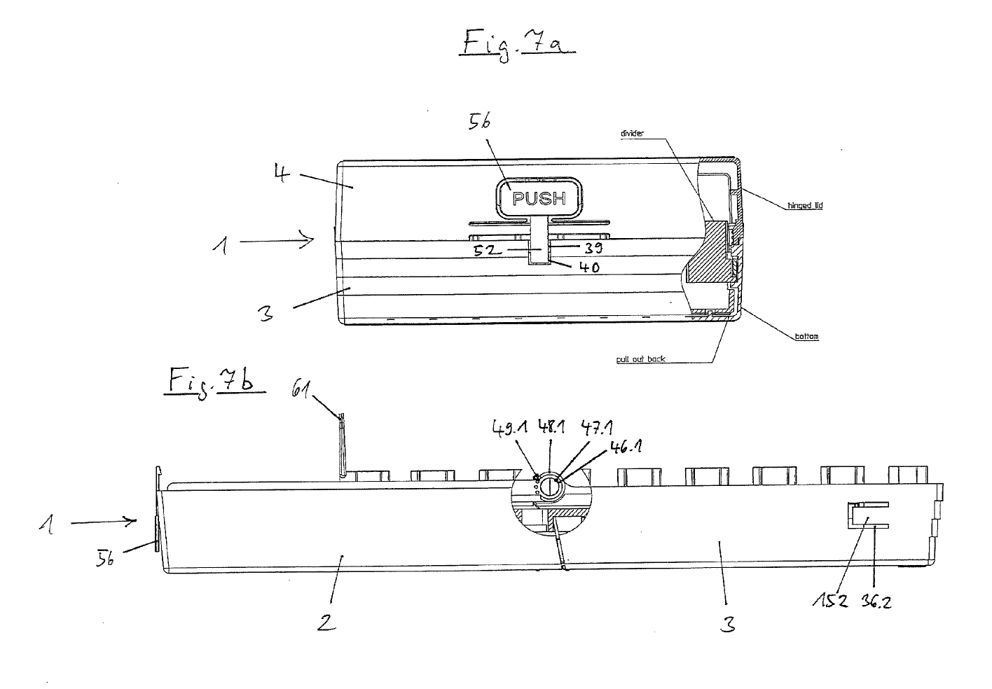

FIG. 9 show an open storage box in an enlarged, perspective partial view of the inside of the hinge and adjacent carrier elements;

FIG. 10 shows carrier elements of the storage box in the coupled and uncoupled state in a perspective view at an angle from above and from the side.

### DETAILED DESCRIPTION OF THE INVENTION

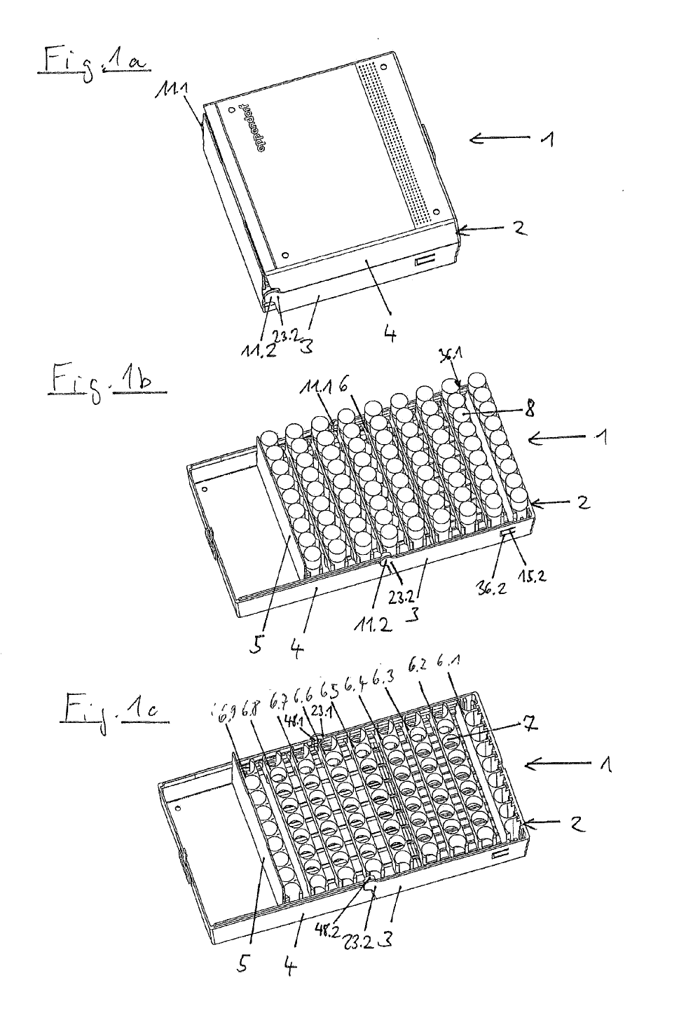

According to FIG. 1, the storage box 1 has a box housing 2, which comprises a housing base 3 and a housing lid 4, wherein the housing base 3 and the housing lid 4 are connected with one another by a hinge. Furthermore, the box housing 2 comprises a slider 5. A plurality of strip-shaped carrier elements 6 is disposed in the box housing. The exemplary embodiment has nine carrier elements 6.1 to 6.9.

The carrier element 6.1 is connected firmly with the housing base 3 and the carrier element 6.9 is connected firmly with the slider 5. The adjacent carrier elements are coupled with one another, so that they can be pushed apart up to a gap and pushed together until their side surfaces are in contact with one another.

In FIG. 1a, the carrier elements 6 are pushed together and the box housing 2 is closed by closing the housing lid 4 against the housing base 3.

In FIG. 1b, the housing lid 4 is opened by an angle of 180° and the carrier elements 6 are pulled apart, so that there is a gap, which preferably is finger-wide, between adjacent carrier elements. Tubular vessels 8, which can easily be removed in the pulled-apart position of the carrier elements 6, even if the user is wearing gloves, are inserted in holders 7 of the carrier elements 6. Each carrier element 6 has nine holders.

FIG. 1c shows the storage box 1 in the opened state and with pulled-apart carrier elements, 6, which are ready to be loaded with vessels 8.

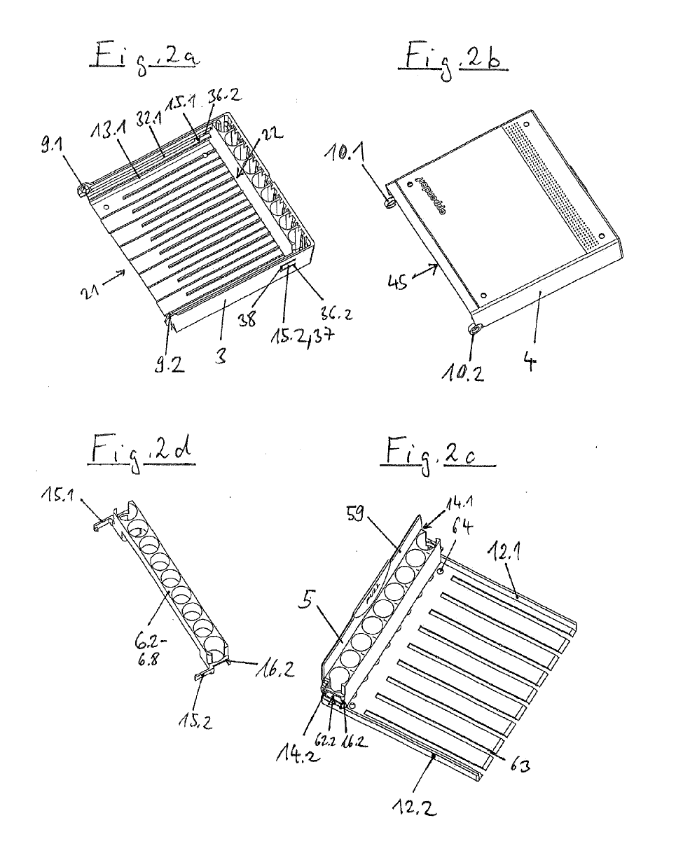

All components from which the storage box 1 can be assembled are shown in FIG. 2. For this purpose, two sides of the housing base 3 have first hinge parts 9.1, 9.2 and the housing lid 4 has second hinge parts 10.1, 10.2, which can be connected with the first hinge parts 9.1, 9.2 in order to form a hinge 11.1, 11.2 for swiveling the housing lid 4 with respect to the housing base 3 (see FIG. 1).

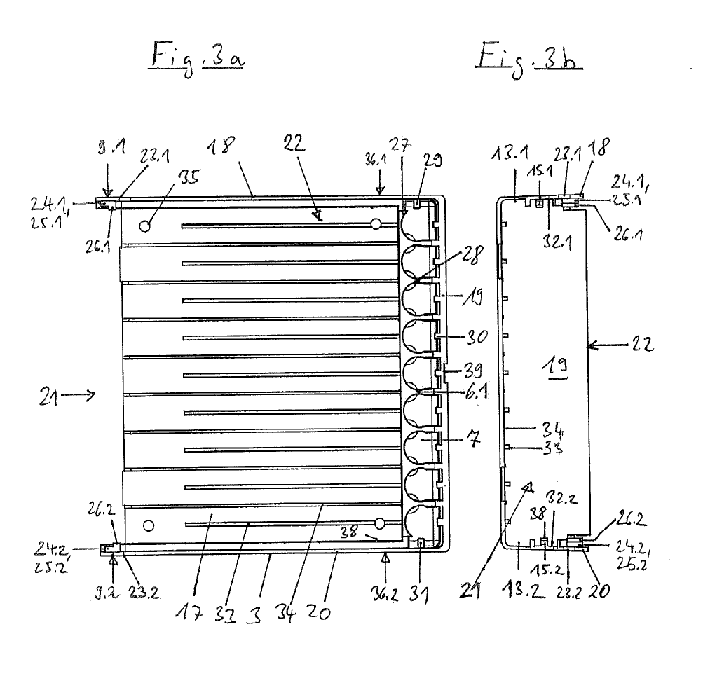

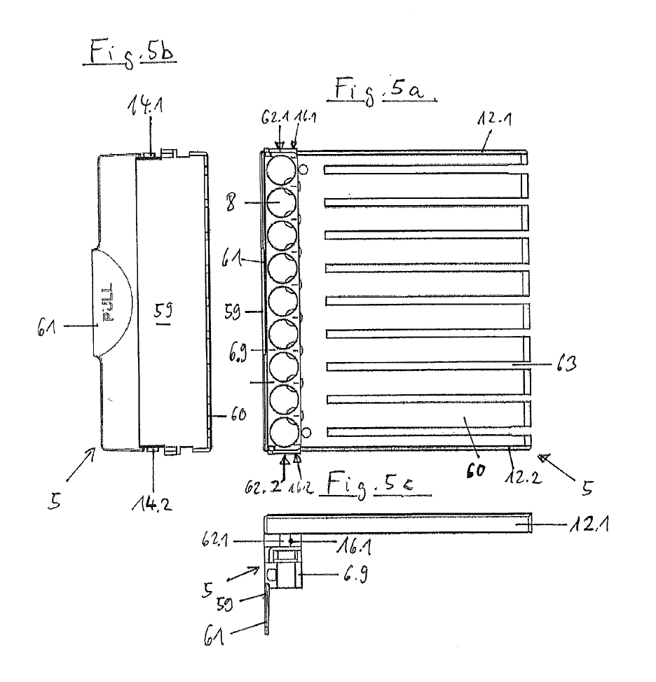

At both sides, the slider 5 has guide rails 12.1, 12.2, which can be pushed into guide grooves 13.1, 13.2 of the housing base 3 (see FIG. 3b). Furthermore, at the two sides of the slider 5, there are locking elements 14.1, 14.2 (see FIG. 5b), which, when the housing lid 4 is open, can be inserted into the hinge 11.1, 11.2 by shifting the slider 5 into the housing base 3. The slider 5 can be locked in the pushed-in position by closing the housing lid 4.

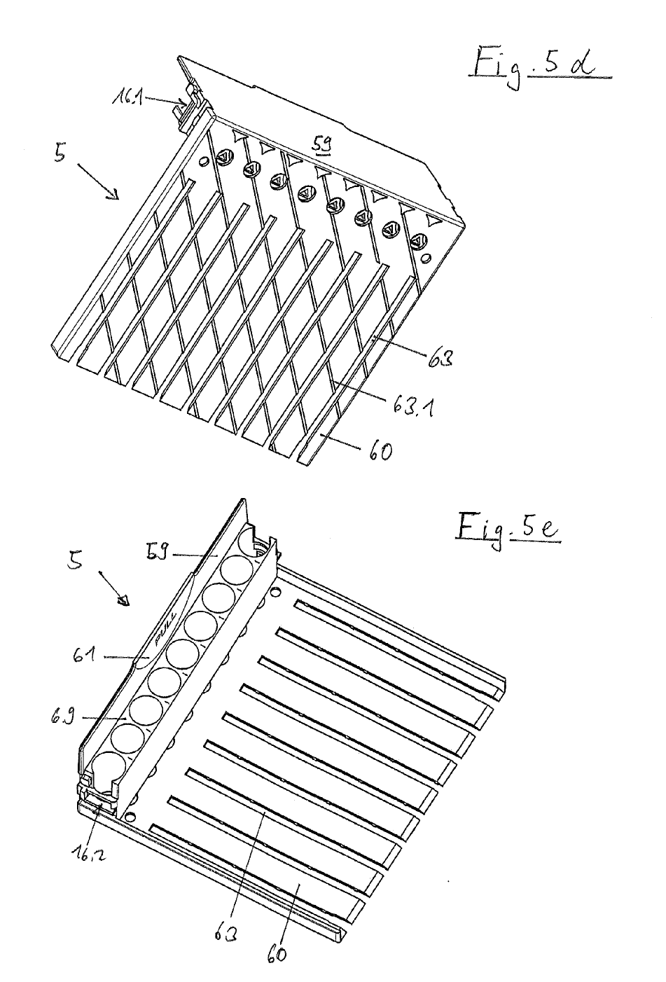

Furthermore, the carrier elements 6.2-6.8 have first coupling elements 15.1, 15.2 at each of the two ends, which protrude from one side and second coupling elements 16.1, 6.2 (see FIG. 6c) next to the other side for coupling with the adjacent carrier elements 6. Aside from the carrier elements 6.1, which are firmly connected with the housing base 3, the latter has coupling elements 15.1, 15.2 for coupling to the adjacent carrier element 6.2. Furthermore, the carrier element 6.9, which is firmly connected with the slider 5, has coupling elements 16.1, 16.2 (see FIG. 5c, d) for coupling with the adjacent carrier element 6.8.

In accordance with FIG. 3, the housing base 3 has an essentially rectangular bottom wall 17. Side walls 18, 19, 20 protrude from three edges of the bottom wall. At the rear edge of the bottom wall 17, the housing base 3 has a rear housing opening 21 between the two parallel, adjacent side walls 18, 20. The upper edges of the side walls 18, 19, 20 form the boundary of an upper housing opening 22 on three sides. The rear housing opening 21 adjoins the rear edge of the upper housing opening 22.

The first hinge parts 9.1, 9.2 are disposed at the upper rear edge of the two parallel side walls 18, 20. As can be seen better in FIG. 1, the parallel side walls 18, 20 are formed there into bracket-like articulated girders 23.1, 23.2, which are directed at an angle rearwards and upwards. The first hinge parts 9.1, 9.2 have spigots 24.1, 24.2, which protrude from the insides of the articulated girders 23.1, 23.2, and which, in this case, have a base 25.1, 25.2 with a full cross-section and, protruding therefrom, a spigot part 26.1, 26.2 with a semicircular cross-section (see FIG. 2a).

The rear edges of the parallel side walls 18, 20, and the rear edge of the bottom wall 17 protrude a small amount forward beneath the first hinge parts 9.1, 9.2 (see FIG. 2a, 3a).

The first carrier element 6.1 is formed at the inside of the front side wall 19. The front side wall 19, a rear carrier wall 27 and bars formed in between surround the holders 7 of the first carrier element 6.1. The holders are surrounded by partly cylindrical surfaces of the aforementioned structures and by ribs 29, 30, 31, which protrude inward from the side walls 18, 19, 20, so that vessels 8 with a cylindrical shell of a defined size can be held therein with little clearance. The front ribs 30 are marked (for example by an individual number) preferably at the upper side, in order to make it easier to identify the holders 7.

The guiding grooves 13.1, 30.2 are disposed below at the insides of the parallel side walls 18, 20. Moreover, at the insides of the parallel side walls 18, 20, there are further guiding elements in the form of grooves 32.1, 32.2 (see FIGS. 2a, 3b) for guiding the carrier elements 6.2 to 6.9.

Supporting ribs 33, which extend parallel to the guiding grooves 13.1, 13.2, protrude from the upper side of the bottom wall 17. The supporting ribs 33 extend from the carrier element 6.1 up to a small distance from the rear edge of the bottom wall 17.

Moreover, sliding ribs 34 protrude from the upper side of the bottom wall 17. The lower sliding ribs 34 are disposed between the supporting ribs 33 and protrude less from the bottom wall 17 then do the supporting ribs 33.

Finally, the bottom wall 17 has drainage holes 35.

Preferably, the housing base 3 is injection molded in one piece from plastic. Alternatively, the carrier element 6.1 can be firmly connected subsequently with other parts of the housing base 3, for example by welding, gluing or locking in place. Preferably, it is produced from polycarbonate. Alternatively, it may be produced in particular from polypropylene, polystyrene, polyamide or an acrylonitrile-butadiene-styrene copolymer.

The first coupling elements 15.1, 15.2 are formed behind the carrier element 6.1 in the parallel side walls 18, 20. These are brackets, which extend rearward in elongated holes 36.1, 36.2 (see FIG. 2a) in the side walls 18, 20 parallel to the guiding grooves 13.1, 13.2. The brackets have a strip-shaped section 37, which is connected at the front in one piece with the respective side wall 18, 20, and at the back has a hook 38, which protrudes from the inside of the parallel side walls 18, 20.

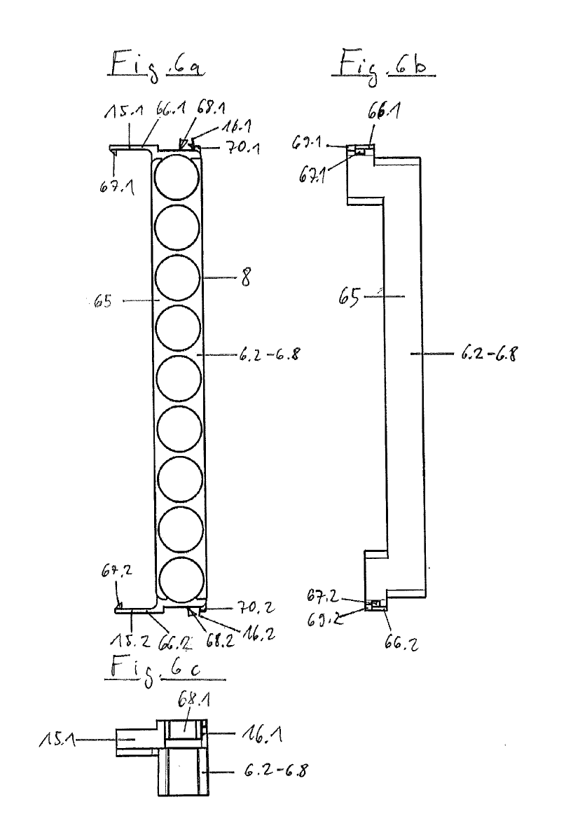

At the outside, the front side wall 19 has a locking groove 39, which extends a small distance downward from the upper edge and has a depression 40 at the lower end (see FIG. 7a).

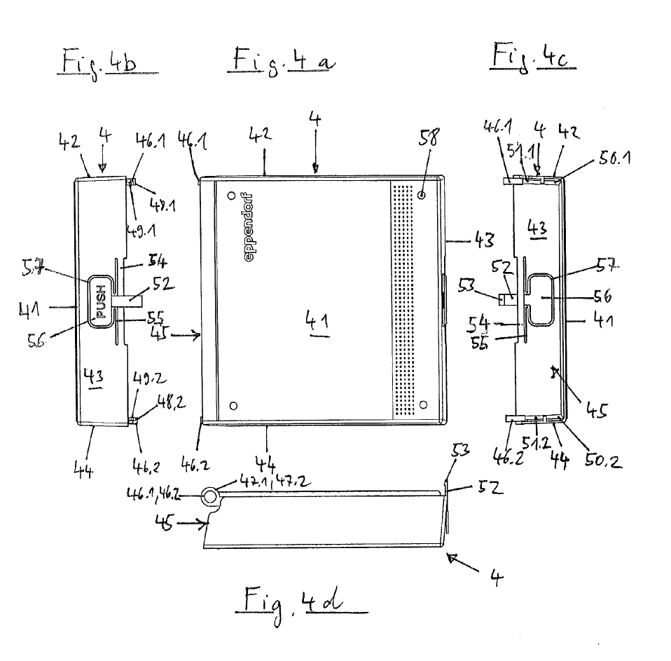

In accordance with FIG. 4, the housing lid 4 has a rectangular covering wall 41 with lid side walls 42, 43, 44 protruding from three edges. Next to the rear edge (in relation to the closed position of the housing lid 4) of the covering wall 41, there is a rear lid opening 45 between the rear edges of the parallel lid side walls 42, 44.

At the lower edge (in relation to the closed position of the housing lid 4) at the rear end, the lid side walls 42, 43, 44 have outwardly protruding second hinge parts 46.1, 46.2. The second hinge parts 46.1, 46.2 in each case comprise a bearing eye 47.1, 47.2, which protrudes from the lid side wall 42, 44 to the rear. At the inside of each bearing eye 47.1, 47.2, protrudes a sleeve 48.1, 48.2 (see FIG. 1c). Each sleeve 48.1, 48.2 is partly cylindrical, since a peripheral section, pointing to the front, is missing. In this location, each sleeve has a forwardly pointing sleeve opening 49.1, 49.2 (see FIG. 7b).

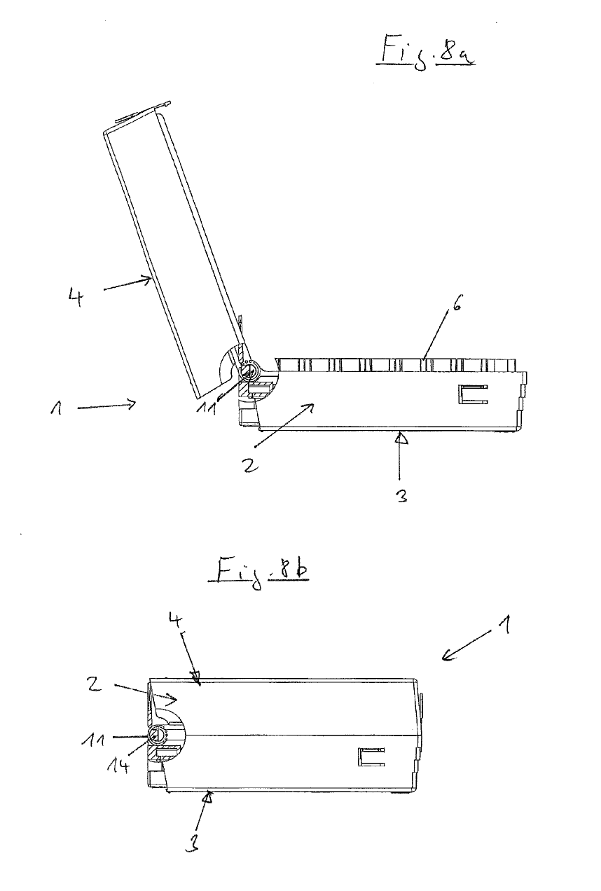

Next to the covering wall 4, guiding grooves 50.1, 50.2 are disposed at the insides of the parallel lid side walls 42, 44 and, in the open position of the housing lid 4, continue the guiding grooves 13.1, 13.2 of the housing base (see FIG. 9).

Furthermore, at the inside of the parallel lid side walls 42, 44, underneath the guiding grooves 50.1, 50.2, there are grooves 51.1, 51.2 for guiding the first coupling elements 15.1, 15.2, which, in the open position of the housing lid 4, continue the guiding grooves 32.1, 32.2, which are formed in the housing base 3 (see FIG. 9).

Above the second hinge parts 46.1, 46.2, the rear edge of the two parallel lid side walls 42, 44 and of the covering wall 41 springs back a little. In the open position of the housing lid 4, the edge of the housing lid 4, which protrudes backward, is in contact with the edge of the housing base 3, which protrudes forward (see FIG. 9).

With the bearing eyes 47.1, 47.2, the housing lid 4 can be snapped onto the fully cylindrical base 25.1, 25.2 of the spigots 24.1, 24.2, so that the partially cylindrical spigot parts 26.1, 26.2 extend into the sleeves 48.1, 48.2 (see FIGS. 7b and 9).

The front lid side wall 43 has a locking hook 52, which protrudes from the lower edge of the lid side wall 43. The locking hook 52 is strip-shaped and, at the bottom, has a hook end 53, which protrudes inward. The locking hook 52 is connected in one piece with a strip-shaped section 54 at the lower edge of the front lid side wall 43. At the top, the strip-shaped section 54 is separated from the rest of the front lid side wall 43 by slots 55. Above the strip-shaped section 54, the locking hook 52 is connected in one piece with a pushbutton, 56, which is disposed in a complementary recess 57 in the front lid side wall 43. The locking hook 52 can be swiveled towards the outside by pressing the pushbutton 56.

When the housing lid 4 is closed, the locking hook 52 slides downward in the locking groove 39 until the hook end 53 engages the depression 40. The hook end 53 can be raised out of the depression 40 by pressing the pushbutton 56 so that the housing lid 4 can be swiveled up.

Four continuous drainage holes 58 are disposed in the covering wall 41.

Preferably, the housing lid 4 is injection molded in one piece from plastic. Preferably, the housing lid is constructed from polycarbonate. Alternatively, it may be produced in particular from polypropylene, polystyrene, polyamide or an acrylonitrile-butadiene-styrene copolymer.

In accordance with FIG. 5, a slider 5 has a rear side wall 59 and a bottom wall part 60, which is connected in one piece therewith. The dimensions of the rear side wall 59 are such, that the latter can fill the housing opening 21 and the rear lid opening 45, when the box housing 1 is closed.

The rear side wall 59 has an upwardly protruding bracket-shaped handle 61.

At the inside of the rear side wall, the carrier element 6.9 is firmly disposed on the bottom wall part 60. The carrier element 6.9 has a strip-shaped basic body with nine cylindrical holders 7. At the two front ends, the basic body has second coupling elements 16.1, 16.2 in the form of locking edges, surrounding depressions 62.1 62.2, next to the front edge of the carrier element 6.9 (see FIG. 2c).

At the two longitudinal sides, aligned perpendicularly to the longitudinal axis of the carrier element 6.9, the guide rails 12.1, 12.2 protruding upward from the essentially rectangular bottom wall part 60. In between, the bottom wall part 60 has parallel slots 63, the dimensions of which are such that they can accommodate the supporting ribs 33, so that the supporting ribs 33 protrude upwards out of the slots 63. At the top, the front edge of the bottom wall part 60 has an inclined section.

Parallel upper sliding ribs 63.1, which protrude downward from the underside of the bottom wall part 60, extend at an angle to the slots 63.

In addition, there are two continuous drainage holes 64 in the bottom wall part.

The locking elements, in the form of spigots with a partly cylindrical cross-section, protrude from the two outer edges of the rear side wall. The dimensions of the locking elements 14.1, 14.2 are such, that they can be pushed through the sleeve openings 50.1, 50.2 into the sleeves 48.1, 48.2 of the second hinge parts 10.1, 10.2, when the housing lid 4 is in the open position (see FIG. 7b). In this position of the locking elements 14.1, 14.2, the housing lid can be swiveled shut, the sleeves enveloping the locking elements at the rear (see FIG. 9).

Preferably, the slider 5 is injection molded in one piece from plastic. Alternatively, the carrier element 6.9 can be firmly connected subsequently with other parts of the slider 5, for example by welding, gluing or locking in place. Preferably, the slider is constructed from polycarbonate. Alternatively, it may be produced in particular from polypropylene, polystyrene, polyamide or an acrylonitrile-butadiene-styrene copolymer.

In accordance with FIG. 6, each carrier element 6.2 to 6.8 has a strip-shaped basic body 65, in which holders 7 are disposed in the form of cylindrical holes. First coupling elements 15.1, 15.2 protrude in the form of brackets from the two ends of the basic body on one side of the basic body. The brackets have a strip-shaped section 66.1, 66.2, with an inwardly protruding locking hook 67.1, 67.2 at the free end. The strip-shaped sections 66.1, 66.2 are disposed perpendicularly to the longitudinal axis of the basic body 65.

Furthermore, the strip-shaped basic bodies 65 have an engagement area in the form of a depression 68.1, 68.2 at the two ends next to the coupling elements. The depressions 68.1, 68.2 are bounded adjacent to the front side of the basic body 65 by second coupling elements 16.1, 16.2 in the form of locking edges.

At both ends in the region of the connection of the first coupling elements 15.1, 15.2, the carrier elements 6.2 to 6.8 have downwardly protruding rear base elements 69.1, 69.2. Furthermore, at two ends below the locking edges 16.1, 16.2, they have downwardly and outwardly protruding front base elements 70.1, 70.2. The carrier elements can be placed horizontally with the base elements 69.1, 69.2, 70.1, 70.2 on a flat support.

Each carrier element 6 has an individual marking.

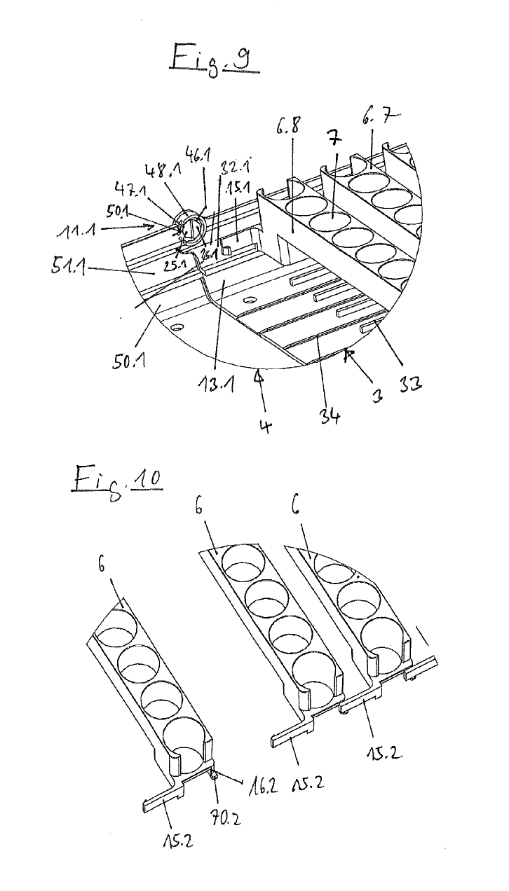

Two carrier elements 6.2 to 6.8 can be connected with one another in that the brackets 15.1, 15.2 of the one carrier element are snapped with their locking hooks 67.1, 67.2 behind the locking edges 16.1, 16.2 of the other carrier element. The strip-shaped sections 66.1, 66.2 then rest on the upper sides of the front base elements 70.1, 70.2 (see FIG. 10).

For the assembly of the storage box 1, seven carrier elements 6.2 to 6.8 are coupled together by means of the coupling elements 15.1, 15.2, 16.1, 16.2. The coupled carrier elements 6.2 to 6.8 are placed on the slider 5 and, by means of its coupling elements 15.1, 15.2, coupling element 6.8 is coupled with the coupling elements 16.1, 16.2 of the carrier elements 6.9. The slider 5 is pushed with the guide rails 12.1, 12.2 into the guiding grooves 13.1, 13.2 of the housing base 3, until the coupling elements 15.1, 15.2 of the housing base 3 are coupled together with the coupling elements 16.1, 16.2 of the carrier element 6.2 and the locking elements 14.1, 14.2 are in contact with the spigot parts 26.1, 26.2. After that, the second hinge parts 10.1, 10.2 of the housing lid 4 are snapped together with the first hinge parts 9.1, 9.2 and the housing lid is closed and interlocked with the housing base part. The rear side wall 59 and the carrier elements 6.2 to 6.8 are secured hereby in the pushed-together arrangement of the housing base 3. No further components and assembly steps are required to produce the storage box 1.

For use, the housing lid 4 is unlocked by pressing the pushbutton 56 and then swiveled through 180°. For inserting vessels 8, the carrier elements 6 are pushed apart by pressing against the handle 61, until the locking hooks 67.1, 67.2 contact the locking edges 16.1, 16.2 (FIGS. 1c and 7b). Vessels 8 may then be inserted conveniently and manually into the holders 7.

For storage, the carrier elements 6 are pushed together by pressing the handle 61. The carrier elements 6 can be pushed together until they contact one another at their front and rear sides. The locking hooks 67.1, 67.2 move here within the depressions at the ends of the carrier elements 6. After that, the housing lid 4 is closed and locked, as a result of which the rear side wall 59 and the carrier elements 6 are fixed in their pushed-together position.

For removing vessels 8, the housing lid 4 is opened once again, and the carrier elements 6 are pushed apart.

### LIST OF REFERENCE NUMBERS

1 storage box
2 box housing
3 housing base
4 housing lid
5 slider
6.1-6.9 carrier elements
7 holders
8 tubular vessels
9.1, 9.2 first hinge parts
10.1, 10.2 second hinge parts
11.1, 11.2 hinge
12.1, 12.2 guide rails
13.1, 13.2 guiding grooves
14.1, 14.2 locking elements
15.1, 15.2 first coupling elements
16.1, 16.2 second coupling elements
17 bottom wall
18, 19, 20 side walls
21 rear housing opening
22 top housing opening
23.1, 23.2 hinge carrier
24.1, 24.2 spigot
25.1, 25.2 base
26.1, 26.2 spigot parts
27 carrier wall
28 bars
29, 30, 31 protruding ribs
32.1, 32.2 grooves
33 supporting ribs
34 lower sliding ribs
35 drainage holes
36.1, 36.2 elongated holes
37 section
38 hook
39 locking groove
40 depression
41 covering wall
42, 43, 44 lid side walls
45 lid opening
46.1, 46.2 second hinge parts
47.1, 47.2 bearing eye
48.1, 48.2 sleeves
49.1, 49.2 sleeve opening
50.1, 50.2 guiding grooves
51.1, 51.2 grooves
52 locking hook
53 hook end
54 strip-shaped section
55 slot
56 pushbutton
57 recess
58 drainage holes
59 rear side wall
60 bottom wall part
61 handle
62.1, 62.2 depressions
63 slot
63.1 upper sliding ribs
64 drainage holes
65 basic body
66.1, 66.2 section
67.1, 67.2 locking hooks
68.1, 68.2 depression
69.1, 69.2 base elements
70.1, 70.2 base elements

1. A storage box for a plurality of tubular vessels or other elongated objects has
a box housing (2) comprising
a housing base (3) with a bottom wall (17), side walls (18, 19, 20) and a top housing opening (22) and
a housing extension (4), which can be shifted from a stowed position, in which the housing extension (4) forms a compact arrangement with the housing base (3), into an extended position, in which the housing extension (4) elongates the housing base (3) in a direction parallel to the bottom wall (17),
several strip-shaped carrier elements (6), which, in each case, have a row of parallel holders (7) for elongated objects (8) and are disposed parallel to and next to one another,
coupling elements (15, 16), which connect adjacent carrier elements (6) with one another, so that they can be moved apart perpendicularly to their longitudinal axes up to a defined distance from one another,
guiding elements (15, 32, 51) at the carrier elements (6) and at the box housing, which, when there is a shift, guide the carrier elements (6) perpendicularly to their longitudinal axes,
wherein, in the stowed position, all carrier elements (6) in the box housing (2) are moved together and, in the extended position, can be shifted apart, so that a portion of the carrier elements (6) is disposed in the housing base (3) and a further portion of the carrier elements (6) is shifted into the housing extension (4).

2. The storage box of claim 1, for which the box housing (2) has a housing lid (4), which can be shifted from a closed position, which covers the top housing opening (22), into an open position, which releases the top housing opening (22).

3. The storage box of claim 2, for which the housing lid (4) is the housing extension, wherein the closed position is the stowed position and the open position is the extended position.

4. The storage box of claim 3, for which the housing lid (4) is connected over a hinge (11) with the housing base (3) and from which the closed position, covering the top housing opening (22), can be folded into an open position, which is directed away from the housing base (3).

5. The storage box of claim 4, for which the housing base (3) has side walls (18, 19, 20), which protrude from three edges of the bottom wall (17), a rear housing opening (21) between two parallel side walls (18, 20) at a fourth edge of the bottom wall (17) and first hinge elements (9) at the edges of the two parallel side walls (18, 20) adjacent to the rear housing opening (21), the housing lid (4) has a covering wall (41), lid side walls (42, 43, 44) protruding from three edges of the covering wall (41), a rear lid opening (45) between two parallel lid side walls (42, 44) at a fourth edge of the covering wall (41) and second hinge elements (10) at the edges of the parallel lid side walls (42, 44) next to the rear lid opening (45), wherein the first and second hinge elements (9, 10) form the hinge (11) between the housing base (3) and the housing lid (4) and a rear side wall (59), which can be shifted, is present and is guided by means of guiding elements (15) at guiding elements (32, 51) of the box housing (2), in the closed position of the housing lid (4) covers the rear housing opening (21) and the rear lid opening (45) and, in the open position of the housing lid (4), can be shifted with carrier elements (6) through the lower, rear housing opening (21) and the rear lid opening (45) into the housing lid (4).

6. The storage box of claim 5, for which the housing base (2) and the rear side wall (59) have locking elements (14, 26, 48), which hold the rear side wall (59) in the closed position of the housing lid (4) in the rear housing opening (21) and the rear lid opening (45).

7. The storage box of claim 6, for which the locking elements (14, 26, 48) have spigot parts (26) with a partially circular cross-section, which protrude from the parallel side walls (18, 20) and spigot parts (14) with a partially circular cross-section, which protrude from the rear side wall, the spigot parts lie in contact with one another in the closed position and complement one another into spigots, and the locking elements have sleeves (48), which protrude from the parallel lid side walls (42, 44, with sleeve openings (49), which extend over a circumferential section, wherein the sleeves (48), in the closed position, surround the moved-together spigot parts (14, 26), so that the side wall (59), which can be shifted, is held fast and, in the open position, the sleeve openings (49) release the spigot parts (14) of the rear side wall (59), so that this can be shifted into the housing lid (4).

8. The storage box of claim 5, for which a carrier element (6.9), adjacent to the rear side wall (59), is connected firmly with the rear side wall and for which a front carrier element (6.1), adjacent to the front side wall (19), is connected firmly with the housing base (3).

9. The storage box of claim 5, for which the edges of the parallel side walls (18, 20), and of the bottom wall (17) underneath the first hinge parts (9) protrude forward and the edges of the parallel lid side walls (42, 44) and of the covering wall (41), adjacent to the rear lid opening (45), in the open position, contact the edges of the parallel side walls (18, 20) and the bottom wall (17), which are protruding forward.

10. The storage box of claim 5, for which the rear side wall (59) is connected at the lower edge with a bottom wall part (60), which engages the housing base (3) in the closed position and, when the rear side wall (59) is shifted, can be shifted partly into the housing lid (4) and out of the housing base (3).

11. The storage box of claim 10, for which the bottom wall (17) has lower sliding ribs (34) on the upper side and the bottom wall part (60) has upper sliding ribs (63.1) on the underside, wherein the upper sliding ribs (63.1) and the lower sliding ribs (34) are directed at an angle to one another, so that the upper sliding ribs and the lowest sliding ribs (34) contact one another at crossing places.

12. The storage box of claim 1, for which the coupling elements (15, 16) have brackets, which protrude on the same side from the two ends of the carrier elements (6), perpendicularly to the longitudinal axis thereof and have locking hooks (67) at the free ends, which engage an engagement region (62, 68), which is bounded by a latching protrusion at the lateral edges of an adjacent carrier element.

13. The storage box of claim 12, for which the coupling elements (15) of the carrier elements (6) are guiding elements of the carrier elements and the guiding elements (32, 51) of the box housing (2) are grooves or parallel protrusions at the insides of the parallel side walls (18, 20) and/or the parallel side walls (42, 44) of the lid, which are engaged by the coupling elements (15).

14. The storage box of claim 1, for which each carrier element (6) is provided with an individual first marking and for which the box housing (2) has individual second markings next to each row with holders (7) of different carrier elements (6).

15. The storage box of claim 1, for which there is a stacking aid at the underside of the bottom wall (17) and at the upper side of the covering wall (41).

16. The storage box of claim 1, for which the housing base and/or the housing lid have at least one drainage hole.

17. The storage box of claim 1, which has nine carrier elements (6) with nine holders (7) each.

18. The storage box of claim 1, for which there is an anti-rotation device at the lower end of each holder (7).

19. The storage box of claim 1, which is produced partly or completely from polycarbonate.
